(19) United States
(12) Patent Application Publication
(10) Pub. No.: US 2004/0011877 A1
(43) Pub. Date: Jan. 22, 2004

(54) System for a card having data embedded therein

(76) Inventor: Hans U. Reppermund, Cheswick, PA (US)

Correspondence Address: JAMES RAY & ASSOCIATES, 2640 PITCAIRN ROAD, MONROEVILLE, PA, 15146, US

(21) Appl. No.: 10/199,853

(22) Filed: Jul. 19, 2002

(51) Int. Cl. G06K 7/08; G06K 19/06

(52) U.S. Cl. 235/493; 235/449

(57) ABSTRACT

An improved card having data embedded therein, such card comprising a first member having a predetermined size and a generally rectangular shape, and a predetermined plurality of magnetic strips having data embedded therein located in predetermined areas of the aforementioned first member, and the data in each of such predetermined plurality of magnetic strips being identical.

### FIELD OF THE INVENTION

The present invention generally relates to a card with a magnetic strip containing data, and reader for the card. More particularly, the invention relates to a card with a predetermined plurality of magnetic strips containing the same data, whose size and shape are the same as a credit card, and a reading system for the card.

### BACKGROUND OF THE INVENTION

Credit card type cards (hereafter referred to as a “card”) are used for many purposes these days, from making purchases to allowing access to a secured area. These cards are all of a similar size and shape, and utilize a single magnetic strip that contains information, such as an account number or security code.

The readers for the magnetic strips on these cards only have one location for the retrieval of data. Using a card with a single strip in a reader with a single reading location requires that the card be inserted in only a single orientation. In certain situations, a machine can commandeer a card from the user if it is not properly inserted, and will require the user going thru a process via the issuer of the card to regain possession of the card.

If the card is not inserted in the proper manner, it can be very inconvenient to the card user, especially when many of the readers are located in outdoor locations, and many transactions are made in less than optimal lighting conditions. Under conditions such as those listed above, a user can be placed in inclement weather such as rain, snow or temperature extremes for extended periods of time while finding the proper orientation of the card to the reader. Poor lighting or nighttime conditions could also cause a card user to spend extra time determining the proper orientation of a card. In certain instances, this extended period of time spent determining the proper card to reader orientation may allow a user to be placed in a less than desirable situation or worse, a situation where a theft occurs.

Another shortcoming of the current card and reader single orientation arrangement is that those with less than optimal vision will have a difficult time distinguishing the proper orientation of the card, and may incur the same difficulties described above.

Still another shortcoming of the current credit-type card is that when the single magnetic strip on the card is incapacitated in any way, the card is rendered useless, and a new card must be issued. The reissuing of a credit card causes additional expenses to be incurred by the issuer, and causes an inconvenience to the user while waiting for the new card to arrive.

A further shortcoming of the single orientation of the current credit-type card is shown when it is used as a medical information access card. In this application, there are times when the speed of access to data is critical, and one does not have the extra time that is needed to determine which is the proper card orientation for insertion into the card reader. In this instance, if the card is inserted incorrectly, it can delay the onset of proper emergency medical treatment. In an emergency situation, this delay can be harmful or even fatal.

The current card reader technology offers similar limitations and shortcomings as those described in the preceding paragraphs for the card, in that the reader only utilizes one location for the reading of the cards magnetic strip.

### SUMMARY OF THE INVENTION

In one aspect, the invention generally features an improved card having data embedded therein. The card having data embedded therein comprising a first member having a generally rectangular shape and having a predetermined plurality of magnetic strips located in predetermined areas of the first member.

In another aspect, the invention generally features an improved reading mechanism for a card having data embedded therein. The improved reading mechanism includes a housing member having a predetermined shape and a slot like opening disposed in said housing member for receiving the card like member therein. The improved reading mechanism includes a predetermined number of reading heads disposed at predetermined locations adjacent the slot like opening and are contained within the housing member of the reading mechanism.

### OBJECTS OF THE INVENTION

It is, therefore, a primary object of the present invention to provide an improved system for a card having data embedded therein which will minimize and or eliminate the possibility of a card having data embedded therein from being inserted into the reader in an improper orientation.

Another object of the present invention is to provide an improved system for a card having data embedded therein which will allow continued use if one of the magnetic strips becomes non-functional.

A further object of the present invention is to provide an improved system for a card having data embedded therein which minimize the issuer having to send a new card to the user.

Still another object of the present invention is to provide an improved system for a card having data embedded therein which minimizes inconvenience to the user of the card.

Yet another object of the present invention is to provide an improved system for a card having data embedded therein which offers cost savings to the issuer of the card.

It is still a further object of the present invention to provide a reader for a card having data embedded therein that will allow its continued use if one of the readers were to become non-functional.

In addition to the above-described objects and advantages of the improved system for a card having data embedded therein of this invention described above, various other objects and advantages of the present invention will become more readily apparent to the persons who are skilled in the same and related arts from the following more detailed description of the invention, particularly, when such description is taken in conjunction with the attached drawing figures and the appended claims.

### DESCRIPTION OF THE DRAWING

FIG. 1 is a top view of a card with one magnetic strip per side, and shows the front of the card.

FIG. 2 is a top view of a card with one magnetic strip per side, and shows the back of the card.

FIG. 3 is top view of a card with two magnetic strips per side, and shows the front of the card.

FIG. 4 is top view of a card with two magnetic strips per side, and shows the back of the card.

FIG. 5 is a cut-away of a front view of the card reader currently used, with only one magnetic strip reader.

FIG. 6 is a cut-away of a front view of a card reader according to the preferred embodiment, with a plurality of magnetic strip readers.

### DETAILED DESCRIPTION OF THE PREFERRED EMBODIMENT

Prior to proceeding to a much more detailed description of the present invention, it should be noted that identical components which have identical functions have been identified with identical reference numerals throughout the several views illustrated in the drawing figures for the sake of clarity and understanding of the invention.

The present invention will now be described by way of a particular preferred embodiment, reference being had to the accompanying drawing, wherein:

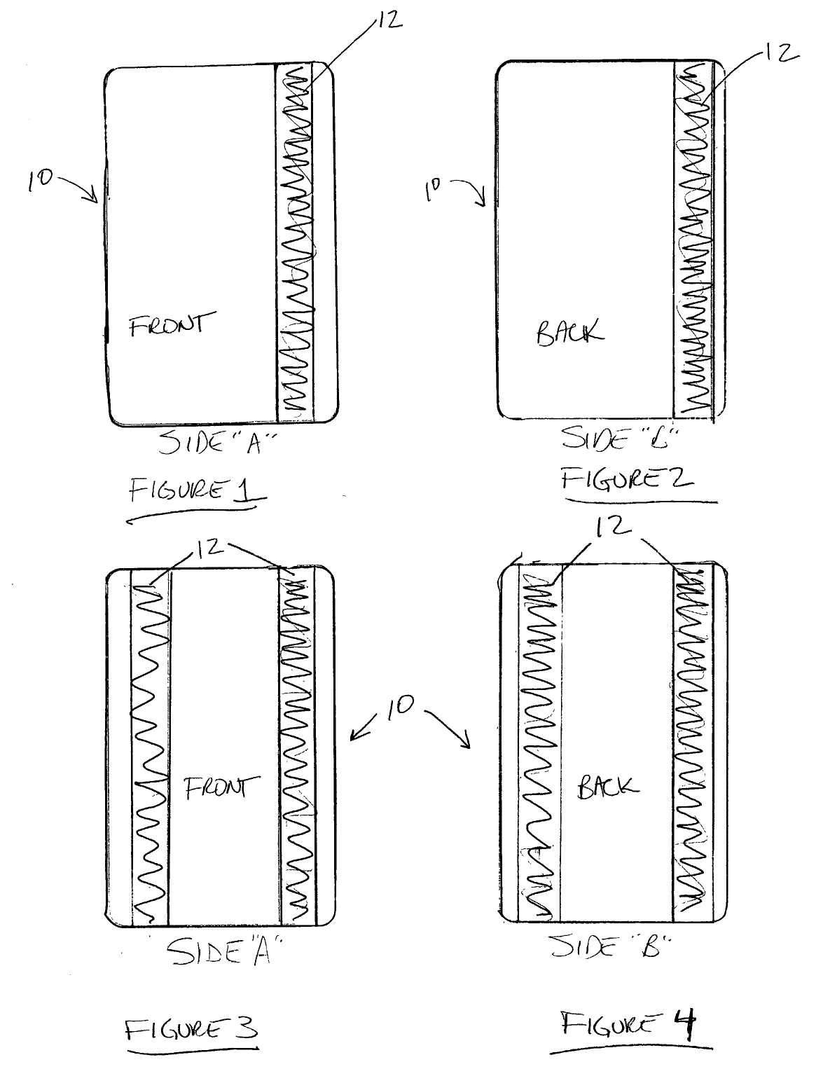

Referring initially to FIGS. 1 and 2 an improved card having data embedded therein constructed according to the invention is generally indicated by reference numeral 10. FIG. 1 shows the front side of such a card, while FIG. 2 shows the back side of the card, which includes the magnetic strip.

The improved card 10 having data embedded therein as has been illustrated in FIGS. 1 and 2 generally includes a plurality of magnetic strips 12 embedded in them, with at least one per side. These cards 10 are usually rectangular in shape, and the magnetic strips 12 are placed in a location such that they are able to be read by the appropriate reader 20, and are generally located in a predetermined location on both sides of the card.

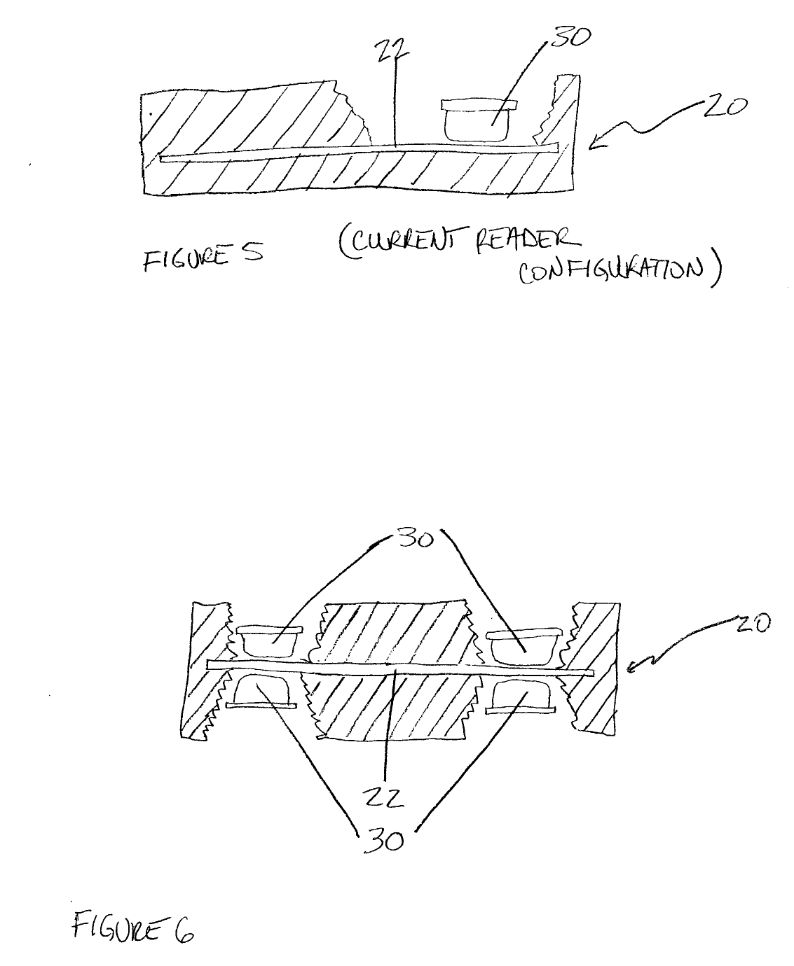

FIGS. 3 and 4 show an improved card 10 having data embedded therein with a plurality of magnetic strips 12 embedded within them, with at least two per side. These cards 10 are usually rectangular in shape, and the magnetic strips 12 are placed in locations such that they are able to be read by the appropriate reader 20, and are generally located in predetermined locations on both sides of the card 10.

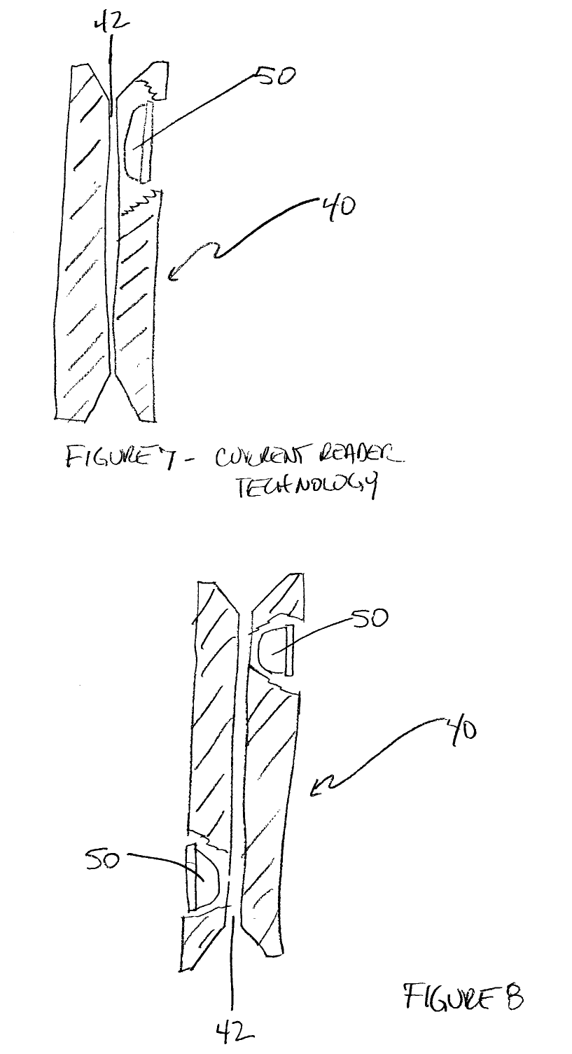

FIGS. 5 and 6 show a cut-away view of the front side of a reading mechanism 20 for a card 10 having data embedded therein and an associated magnetic reader head 30 for the card 10, along with the slot 22 for insertion of the card 10. FIG. 5 is a view showing current card reader 20 technology, with only one reader head 30. FIG. 6 shows the presently preferred card reading mechanism 20 embodiment, with a predetermined plurality of reader heads 30 placed in predetermined locations. The card 10 would be placed in the reader slot 22, and the magnetic strip 12 on the card 10 would pass along the reader head 30, so that the information could be passed from the card 10 to the reader 20, and to whatever destination required for the transaction to be completed.

FIGS. 7 and 8 show a cut-away view of the front side of a reading mechanism 40 for a card 10 having data embedded therein and an associated magnetic reader head 50 for the card 10, along with the slot 42 for sliding the card 10 there through. FIG. 7 is a view showing current card 10 reader 40 technology, with only one reader head 50. FIG. 8 shows the presently preferred card 10 reading mechanism 60 embodiment, with a plurality of reader heads 50 placed in predetermined locations. The card 10 having data embedded therein would be slid through the slot 42 of the reader 40, and at least one of the magnetic strips 12 on the card 10 would pass along the reader head 50, so that the information could be passed from the card 10 to the reader 40, and to whatever destination required for the transaction to be completed.

While the present invention has been described by way of a detailed description of a particularly preferred embodiment, it will be readily apparent to those of ordinary skill in the art that various substitutions of equivalents may be affected without departing from the spirit or scope of the inventions set forth in the appended claims.

I claim:

1. An improved card having data embedded therein, said card comprising:
(a) a first member having a predetermined size and a generally rectangular shape; and
(b) a predetermined plurality of magnetic strips having data embedded therein, located in predetermined areas of said first member, said data in each of said predetermined plurality of magnetic strips being identical.

2. An improved card having data embedded therein according to claim 1, wherein said card is one of a credit card, a debit card, a security access card, a general information card, and a medical information card.

3. An improved card having data embedded therein according to claim 1, wherein said first member is made from a predetermined material selected from the group consisting of plastic, cardboard, paper and metal.

4. An improved card having data embedded therein according to claim 1, wherein said predetermined plurality of magnetic strips is at least two.

5. An improved card having data embedded therein according to claim 1, wherein said predetermined plurality of magnetic strips is at least three.

6. An improved card having data embedded therein according to claim 1, wherein said predetermined plurality of magnetic strips is at least four.

7. An improved card having data embedded therein according to claim 6, wherein said predetermined material is plastic.

8. An improved reading mechanism for a card having data embedded therein, said improved reading mechanism comprising:
a. a housing member having a predetermined shape;
b. a slot disposed in said housing member for receiving said card having data embedded therein; and
c. a predetermined plurality of reading heads disposed at predetermined locations adjacent said slot and within said housing member of said reading mechanism.

9. An improved reading mechanism for a card having data embedded therein according to claim 8, wherein said reading mechanism includes at least two reading heads.

10. An improved reading mechanism for a card having data embedded therein according to claim 8, wherein said reading mechanism includes at least three reading heads.

11. An improved reading mechanism for a card having data embedded therein according to claim 8, wherein said reading mechanism includes at least four reading heads.
